(19) United States
(12) Patent Application Publication
(10) Pub. No.: US 2010/0257175 A1
(43) Pub. Date: Oct. 7, 2010

(54) METHOD, SYSTEM, OR APPARATUS FOR JOINING ONE OR MORE EVENTS

(75) Inventors: Santhosh Srinivasan, Sunnyvale, CA (US); Partha Saha, Oakland, CA (US); Swaroop Jagadish, Sunnyvale, CA (US); Kurt Peterson, San Jose, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware Corporation, Sunnyvale, CA (US)

(21) Appl. No.: 12/417,501

(22) Filed: Apr. 2, 2009

(51) Int. Cl. G06F 17/30

(52) U.S. Cl. 707/741; 707/E17.055

(57) ABSTRACT

Embodiments of methods, apparatuses, devices and systems associated with events and joining events are disclosed.

### FIELD

Embodiments relate to the field of associating one or more events, and more specifically to joining events from one or more streams of events.

### INFORMATION

Web pages may, under circumstances, track a variety of events. For example, a computing apparatus such as a computing apparatus programmed to perform one or more ad-server functions, may transmit one or more advertisements to one or more application programs, such as web browsers, at one or more times. In this example, a computing apparatus, such as a computing apparatus programmed to perform one or more tracking functions, may be operable to track information relating to serving of advertisements as one or more events. In addition, one or more other events may likewise be tracked, such as a time at which an advertisement is displayed to a user, a time at which a user clicks on an advertisement, a time at which a user makes a purchase related to a served or displayed advertisement. Under some circumstances, this may lead to a large quantity of information relating to the various events that may be tracked. Accordingly, solutions for managing or organizing such information may be desirable or advantageous.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flow chart representation of a system or process in accordance with an embodiment;

FIG. 2 is a schematic diagram of a system in accordance with an embodiment; and

FIG. 3 is a schematic diagram of a computing platform or special purpose computing apparatus in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components or circuits that would be known by one of ordinary skill have not been described in detail so as not to obscure claimed subject matter.

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

In at least one embodiment, one or more computing platforms, such as one or more special purpose computing apparatuses, may be involved in one or more aspects of transmitting a web page for display to a user. For example, a user may request a web page using one or more application programs, such as a web browser. In response to such a request, one or more computing apparatuses, such as one or more special purpose computing apparatuses programmed to perform one or more server functions, may transmit signals over an electronic communication network representative of one or more files to the web browser for eventual display to a user. For example, a computing apparatus, such as a special purpose computing apparatus programmed to perform one or more server functions, may transmit one or more signals representing a file via a communication adaptor and a communication network to the web browser corresponding to a particular web page requested by the user, such as a news or entertainment article. In this example, another computing apparatus, such as a special purpose computing apparatus programmed to perform one or more ad server functions, may transmit one or more signals representing a file to the web browser corresponding to one or more advertisements that may be displayed to the user along with the requested web page. In this example, one or more computing apparatuses may keep track of information or events relating to the above transmission. For example, a computing apparatus may track a transmission or serving event relating to a time at which the one or more advertisements were transmitted or served to the web browser. In addition, a computing apparatus may also track a display or user impression event. As used herein a user impression event may refer to an event associated with a time at which the one or more advertisements are displayed to the user via a web browser or other application program, for example. For further example, a computing apparatus may track a selection event. As used herein a selection event may refer to an event associated with a time at which a user may have selected at least one of the one or more advertisements or other files, such as by a user selecting an image or link with one or more input devices, if such a user selection occurs. For yet another example, a computing apparatus may track a conversion event. As used herein a conversion event may refer to an event associated with a time at which a user may have made a purchase relating to at least one of the one or more advertisements, if such a purchase occurs. In addition, a computing apparatus may also track one or more user interactions with the one or more advertisements, such as mouse movements or clicks by a user interacting with an at least in part interactive advertisement, such as a multimedia advertisement, for example. It should, however, be noted that these are merely illustrative examples of events that may be tracked and that claimed subject matter is not limited to the examples provided.

In at least one embodiment, a computing platform and/or special purpose computing apparatus may perform one or more actions relating to the various tracked events. For example, a computing platform and/or special purpose computing apparatus may receive a log file of such events from another computing apparatus and form a file based at least in part on a stream of signals representative of a particular type of event from such a log file. A stream in this example may be one or more signals received by a computing apparatus, wherein the received one or more signals may be associated with a particular type of event. For example, a computing apparatus may receive a stream of one or more signals corresponding to user selection events via a communication network and a communication adaptor. In addition, a stream of events may be one or more signals representative of one or more events received via a communication adaptor and stored in a memory device, such as a memory buffer, queue, storage media, and/or the like. In addition, the stream of events may be one or more signals representative of one or more events and may be received by, and operated on by, one or more processors programmed with one or more instructions to perform one or more function on such signals. In one particular embodiment, such a formed file may comprise formatted uncompressed data and may be stored as one or more uncompressed data files, such as stored in a memory device associated with the computing platform and/or special purpose computing apparatus. For example, while forming a file from signals representative of the stream of events, such as a formatted file including signals representative of various information associated with particular events, such as a time of a particular event, an advertisement associated with a particular event, a user associated with a particular event, a web site associated with a particular event, and/or the like, a computing platform and/or special purpose computing apparatus may also form an index corresponding to that formatted file. In a particular embodiment, the formed index may be stored as one or more signals in a memory device associated with the computing platform and/or special purpose computing apparatus. In addition, signals representative of such an index file may be stored at least partially in compliance with one or more data-base standards, such as in compliance with Berkeley DB standard, for example. In this example, the index may include information relating to one or more events associated with the file, such as one or more pointers to information associated with a particular event. For example, an index file may include one or more signal representative of a location within the formatted file of information associated with a particular event. In an embodiment, a computing platform and/or special purpose computing apparatus may form a formatted file and index file for respective events, such as advertisement serving events; advertisement viewing events, user selection events, user interaction events, user conversion events, and/or the like. In addition, a computing platform and/or special purpose computing apparatus may join signals representing one or more events from respective signals representing streams of events based at least in part on respective formed index files in conjunction with respective formed formatted files. The term join as used herein may refer to a process by which one or more signals corresponding to aspects of an event may be associated with one another. Joining may likewise include forming a signal at least in part representing such an association and may also include transmitting such a signal via a communication adaptor and a network and/or storing such a signal in a storage medium. For example, a join action may be one or more actions in compliance with one or more data-base standards, such as the Berkeley DB standard mentioned above. Event as used herein may refer to one or more things that may occur at one or more times or within one or more time ranges. For example, an event may refer to one or more signals of a particular type being transmitted, received, stored, and/or the like. It should, however, be noted that these are merely illustrative examples relating to joining events and that claimed subject matter is not limited in this regard.

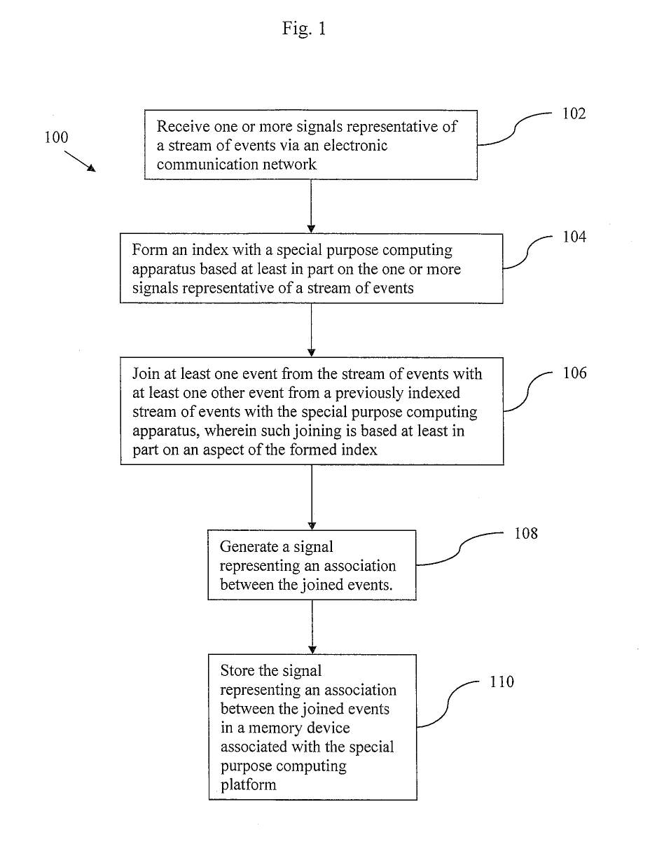

FIG. 1 is a flow chart representation of a system or process 100 in accordance with an embodiment. With regard to box 102, process 100 may receive one or more signals representative of a stream of events via an electronic communication network. For example, process 100 may receive one or more log files representing a stream of events from a computing apparatus via an electronic communication network and a communication adaptor associated with a special purpose computing apparatus. Under some circumstances, process 100 may store the received one or more signals in a memory device associated with a special purposed computing apparatus. With regard to box 104, process 100 may form an index, such as an index file, with a special purpose computing apparatus based at least in part on one or more signals representative of a stream of events. In an embodiment, the index file may include one or more signals representing one or more aspects of one or more events stored in a storage medium. For example, an index file may include information relating to a location of one or more signals representing a particular event within a formatted file of events. With regard to box 106, process 100 may, under some circumstances, join at least one event from a particular stream of events with at least one other event from a previously indexed stream of events with a special purpose computing apparatus, wherein such joining is based at least in part on an aspect of the formed index. For example, a system or process may join an event from one stream of events, such as a stream of advertisement viewing events, with a corresponding event from a previously indexed stream of events, such as advertisement serving events. In this example, a particular advertisement viewing event may be joined with a corresponding advertising serving event. Events may be joined based at least in part on one or more aspects of the respective events. For example, events may be joined based on a time value or a time range. For additional example, events may be joined based at least in part on a user associated with the events, a particular web site associated with the events, a particular advertisement associated with the events, and/or the like. With regard to box 108, process 100 may generate a signal representing an association between the joined events. For example, process 100 may generate a signal corresponding to an entry in a data structure stored in memory and representing an association between such joined events, such as the joined advertisement viewing event and advertisement serving event discussed above. In an embodiment a formatted file corresponding to a stream of events may include information associated with one or more events sorted based at least in part on one or more aspects of such events. For example, the formatted file may include information relating to a web page associated with an event, a user associated with an event, a time associated with an event, and/or the like. As discussed above, such events may correspond to user selections, such as selection events based on a user clicking on an advertisement with one or more input devices, user conversions, such as events relating to a user purchasing a good or service associated with an advertisement, serving events, such as events corresponding to an advertisement being served to a computing apparatus, viewing vents, such as events relating to an advertisement being displayed to a user, media interactions, such as events relating to user interaction with a displayed or served advertisement, and/or the like. With regard to box 110, process 100 may store the signal representing an association between the joined events in a memory device associated with the special purpose computing apparatus. For example, process 100 may store the generated signal in a memory device coupled to a special purpose computing apparatus. It should, however, be noted that these are merely illustrative example relating to joining events and claimed subject matter should not be limited in this regard.

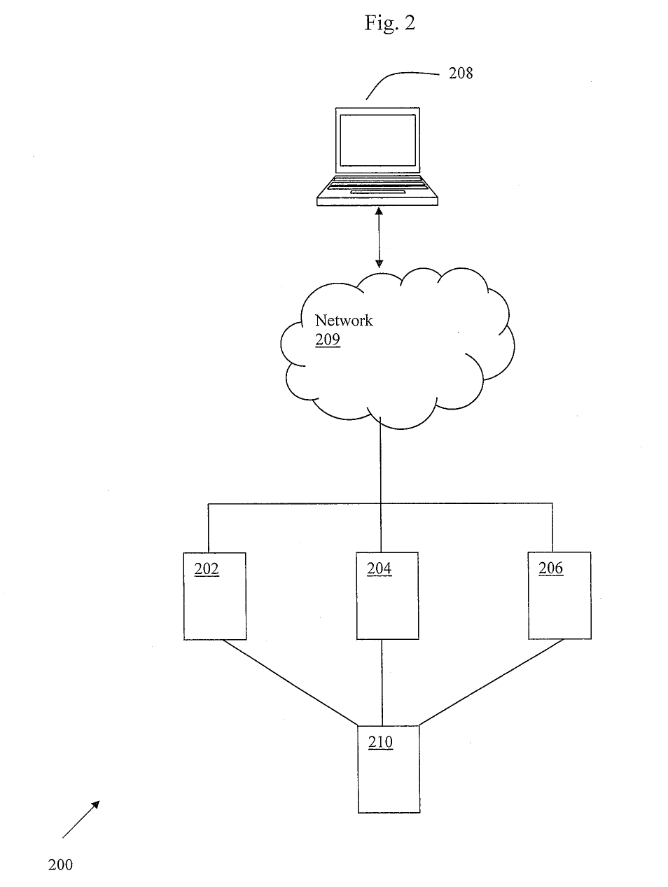

FIG. 2 is a schematic diagram of a system 200 in accordance with an embodiment. With regard to FIG. 2, one or more special purpose computing apparatuses, such as apparatuses 202, 204, and 206 may track one or more events. For example, apparatus 202 may track serving events, such as advertisement serving events. In an embodiment, a user may request a web page, such as by using a web browser and computing apparatus 208. For example, in response to a user request, computing apparatus 208 may generate one or more signals and transmit those signals via network 209 to one or more of apparatuses 202, 204, and 206. At least in part in response to receiving the generated one or more signals corresponding to the user request, a special purpose computing apparatus, such as apparatus 202 may transmit one or more signals representing an advertisement to computing apparatus 208 via network 209. In addition, one or more signals representing a requested web page may also be transmitted to computing apparatus 208 via network 209. In this embodiment, apparatus 202 may track such advertisement serving events, such as by forming one or more signals representing a log file of such events. In an embodiment, apparatus 202, or another special purpose computing apparatus, may form and/or store one or more signals representing an index to such advertisement serving events, such as in response to receiving a stream of signals corresponding to these events or a log file corresponding to these events. In addition, apparatus 202, or another special purpose computing apparatus, may form and/or store one or more signals representing a formatted file corresponding to such received stream of events. For example, the formatted file may include one or more signals corresponding to such events. Such signals may represent information associated with the events, such as a web page associated with a particular event, a user associated with a particular event, a particular advertisement associated with a particular event, a time or time range associated with a particular event, and/or the like. In an embodiment, the formed index file may include signals representing information associated with particular events. For example, the formed index may include one or more signals indicating a location within the formatted file where signals corresponding to a particular event are located. It should, however, be noted that these are merely illustrative examples relating to index files or formed files and that claimed subject matter is not limited in this regard.

In an embodiment, apparatus 204 may likewise track one or more other types of events. For example, apparatus 204 may track information relating to advertisement display events. In this example, apparatus 204 may receive a stream of signals corresponding to advertisement display events. For example, computing apparatus 208 may transmit a signal to apparatus 204 via network 209 if an advertisement has been displayed to a user view a web browser or other application program. In this particular embodiment, apparatus 204 may form one or more signals representing an index to such advertisement display events, such as in response to receiving a stream of signals corresponding to these events or a log file corresponding to those events. In addition, apparatus 204 may form a formatted file corresponding to such received events. For example, the formatted file may include one or more signals corresponding to such events. Such signals may represent information associated with the events, such as a web page associated with a particular event, a user associated with a particular event, a particular advertisement associated with a particular event, a time or time range associated with a particular event, and/or the like. In an embodiment, the formed index file may include signals representing information associated with particular events. For example, the formed index may include one or more signals indicating a location within the formatted file where signals corresponding to a particular event are located. Likewise, apparatus 206 may perform similar actions with regard stored, received, or transmitted signals representing other types of events, such as user click events, user conversion events, user interaction events, and/or the like. It should however, be noted that these are merely illustrative examples relating to indexing events and that claimed subject matter is not limited in this regard.

With regard to FIG. 2, a special purpose computing apparatus, such as apparatus 210 may join signals representing one or more events based at least in part on one or more aspects of those events. For example, apparatus 210 may join a signal representing an advertisement serving event with a signal representing a corresponding advertisement viewing event, user click event, user conversion event, user interaction event, and/or the like. In this example, apparatus 210 may join such events to at least in part determine one or more aspects of related events. For example, by joining or attempting to join an advertisement display event with a user conversion event apparatus 210 may, at least in part, determine whether a user conversion event resulted from a particular advertisement display event and a time or time range at which such an event may have occurred. Join as used herein may refer to a process by which one or more signals corresponding to aspects of an event may be associated with one another. Joining may likewise include forming a signal at least in part representing such an association. In a particular embodiment, events may be joined based at least in part on the formed index. For example, rather than search through a formatted file for a particular event, apparatus 210 may instead search through a corresponding index file. If a particular event is located within the appropriate index file apparatus 210 may obtain additional information relating to that event from the formed file. For example, apparatus 210 may find a particular event in an appropriate index file. Apparatus 210 may then use a signal corresponding to that event to look up signals corresponding to additional information relating to that event in the formatted file. For example, the index file may include one or more signals corresponding to a pointer or location within the formatted file of additional information or signals relating to a particular event. In this example, apparatus 210 may use such a pointer to access one or more corresponding signals in the formatted file relating to a particular event. In addition, apparatus 210 may also form one or more signals corresponding to particular events that have been joined and may store such signals. For example, apparatus 210 may store signal corresponding to joined events in a memory device coupled to apparatus 210. It should, however, be noted that these are merely illustrative examples relating to joining events and claimed subject matter is not limited in this regard.

In addition, a computing platform and/or special purpose computing apparatus may join one or more different types of events. In an embodiment, a computing platform and/or special purpose computing apparatus may join such events based on one or more factors, such as a time of the events, a time range of the events, a relationship between the events, and/or the like. For example, a computing platform and/or special purpose computing apparatus may join an advertisement serving event for a particular user with an advertisement viewing event, a user click event, a user interaction event, a user conversion event, and/or the like, for a particular user. In this example, a computing platform and/or special purpose computing apparatus may join such event by generating and storing in a memory device one or more signals that at least in part indicate an association between such events. For example, a computing platform and/or special purpose computing apparatus may form a signal indicative of a relationship between a particular advertisement serving event and a particular advertisement viewing event. In this example, a computing platform and/or special purpose computing apparatus may also store the generated signal, such as in a memory device associated with the computing platform and/or special purpose computing apparatus.

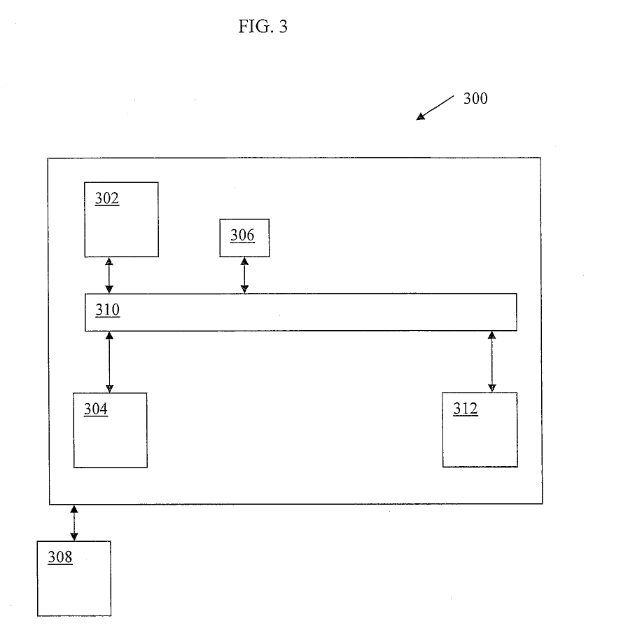

FIG. 3 is a schematic diagram of a computing platform and/or special purpose computing apparatus in accordance with an embodiment 300. Embodiment 300 may comprise a computing platform, such as a special purpose computing apparatus having one or more processors programmed with one or more instructions to perform one or more particular functions and further adapted to track, index, or join one or more events of one or more particular types. In addition, computing apparatus 300 may comprise one or more processors programmed with one or more instructions to perform one or more specific functions, such as processor 302. For example, processor 302 may be programmed with one or more instructions to perform one or more specific functions, such as one or more server functions, one or more tracking functions, and/or the like. Furthermore, computing apparatus 300 may comprise one or more memory devices, such as storage device 304 or computer readable medium 306. In an embodiment, computing apparatus 300 may be operable to index, store, or join one or more signals representing one or more particular types of events or streams of particular types of events. In addition, computing apparatus 300 may comprise one or more network communication adapters, such as network communication adaptor 308. In an embodiment, computing apparatus 300 may be operable, at least in part in conjunction with network communication adaptor 308, to send or receive signals representing one or more actions such as serving content, advertisements and/or the like. In addition, computing apparatus 300 may be further operable, at leas tin part in conjunction with network communication adaptor 308 to receive or transmit signals corresponding to one or more events. Computing apparatus 300 may also comprise a communication bus, such as communication bus 310, operable to allow one or more connected components to communicate under appropriate circumstances. In addition, communication adapter 308 may be operable to send or receive one or more signals corresponding to events, joined events, and/or the like. In an embodiment, computing apparatus 300 may be operable to store signals representing one or more results, such as one or more particular events that have been joined. It should, however, be noted that these are merely illustrative examples relating to a computing apparatus and that claimed subject matter is not limited in this regard.

Some portions of the detailed description above are presented in terms of algorithms or symbolic representations of operations on binary digital signals stored within a memory of a specific apparatus or special purpose computing device or platform. In the context of this particular specification, the term specific apparatus, specific purpose computing apparatus, and/or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals and/or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” and/or the like refer to actions or processes of a specific apparatus, such as a special purpose computer, special purpose computing apparatus, or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding description, various aspects of claimed subject matter have been described. For purposes of explanation, specific numbers, systems or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
receiving one or more signals representative of a stream of events via an electronic communication network;
forming an index with a special purpose computing apparatus based at least in part on the received one or more signals representative of said stream of events;
joining at least one event from said stream of events with at least one other event from a previously indexed stream of events with said special purpose computing apparatus, wherein said joining is based at least in part on an aspect of the formed index; and
storing a signal representing an association between the joined events in a memory device associated with said special purpose computing apparatus.

2. The method of claim 1, wherein the formed index comprises a pointer to a location of an event within a file, wherein said file is formed at least in part in response to forming said index.

3. The method of claim 2, wherein said file comprises one or more signals representative of information associated with one or more events stored in a memory device associated with said special purpose computing apparatus.

4. The method of claim 3, wherein said file comprises an uncompressed file.

5. The method of claim 1, wherein said stream of events comprise user selections, user impressions, user conversions, serving events, or media interactions.

6. The method of claim 1, wherein said aspect of the formed index comprises a time value.

7. The method of claim 5, wherein said time value comprises a range of time values.

8. An article comprising: a storage medium having stored thereon instructions that, if executed by a special purpose computing apparatus, enable said special purpose computing apparatus to:
receive one or more signals representing a stream of events from an electronic communications network;
form an index with a special purpose computing apparatus based at least in part on one or more signals representing said stream of events;
join at least one event from said stream of events with at least one other event from a previously indexed stream of events with said special purpose computing apparatus, wherein said joining is based at least in part on an aspect of the formed index; and
store a signal representing an association between the joined events in a memory device associated with the special purpose computing apparatus.

9. The article of claim 8, wherein the one or more signals representing a stream of events comprises a log file of the events.

10. The article of claim 9, wherein said formed index comprises a signal representative of a location of one or more signals associated with an event within an uncompressed file, wherein said uncompressed file comprised one or more signals representative of information associated with said events.

11. The article of claim 8, wherein said stream of events comprise signals representative of one or more user selections, user impressions, user conversions, serving events, or media interactions.

12. The article of claim 8, wherein said aspect of the formed index comprises a time value, or a range of time values.

13. The article of claim 12, wherein said aspect of the formed index comprises information associated with a particular user, advertisement, or web page.

14. An apparatus comprising:
a computing apparatus comprising one or more processors programmed with one or more instructions to perform one or more particular functions;
wherein said computing apparatus is operable to receive one or more signals representing a stream of events from an electronic communication network;
wherein said computing apparatus is operable to form an index with a special purpose computing apparatus based at least in part on said one or more signals representing said stream of events;
join at least one event from said stream of events with at least one other event from a previously indexed stream of events with said special purpose computing apparatus, wherein said joining is based at least in part on an aspect of the formed index;
generate a signal representing an association between the joined events; and
store said signal representing an association between the joined events in a memory device associated with said computing apparatus.

15. The apparatus of claim 14, wherein said computing apparatus further comprises a communication adaptor for receiving said one or more signals representing a stream of events from an electronic communication network.

16. The apparatus of claim 14, wherein the formed index comprises a signal representative of a location of an event within a file,.

17. The apparatus of claim 16, wherein said computing apparatus is further operable to form said file at least in part in response to forming said index.

18. The apparatus of claim 17, wherein said file comprises one or more signals representative of information associated with one or more events sorted based at least in part on an aspect of said one or more events.

19. The apparatus of claim 14, wherein said stream of events comprise user selections, user impressions, user conversions, serving events, or media interactions.

20. The apparatus of claim 14, wherein said aspect of the formed index comprises a time value or a range of time values.
